(19) United States
(12) Patent Application Publication
(10) Pub. No.: US 2026/0056091 A1
(43) Pub. Date: Feb. 26, 2026

(54) EXTRACTION IMPLEMENT

(71) Applicant: Joseph Weiss, Brooklyn, NY (US)

(72) Inventor: Joseph Weiss, Brooklyn, NY (US)

(21) Appl. No.: 18/815,531

(22) Filed: Aug. 26, 2024

(51) Int. Cl. G01N 1/08

(52) U.S. Cl. CPC G01N 1/08; G01N 2001/085

(57) ABSTRACT

An extraction tool which grasps substrates and specimens by pinching together the ends of two outer prongs but additionally includes a center prong. The outer prongs and the center prongs move relative to each other enabling the center prong to manipulate the substrate or specimen in a way that facilitates grasping by the two outer prongs.

### BACKGROUND

This disclosure is directed to implements or tools for handling substrates in laboratories. One such substrate is a coverslips. In laboratories, cells are grown on top of coverslips located inside lab dishes. To examine the cells, the coverslips are removed from the lab dish and placed onto a glass slide to view under a microscope. That is, the coverslip must be lifted out of the dish, turned over, and placed cell-side down onto the glass slide. The cell layer is then sandwiched between the slide and coverslip and may be viewed or examined with the microscope. The coverslip may be removed and transported for other reasons too. But removing the coverslip from the dish may be challenging. Moreover, the coverslip is often glass and will break if mishandled. This can ruin an experiment.

A typical manner to extract the coverslip is to insert one prong of a tweezer or forceps into the dish and press it against the edge of the coverslip. Then tension is applied to the coverslip to push it against the opposite side of the dish. In this position, one side of the coverslip is gently lifted off of the floor of the dish while that prong is wiggled under the coverslip. Once under, the coverslip is grasped with both prongs of the tweezer or forceps and raised out of the dish. But this method requires mastery to implement. Many times, the coverslip is dropped or worse yet broken in this process.

Accordingly, an implement is needed for safe removal of substrates, such as coverslips, including from a lab dish. An implement which is economical to manufacture yet easy to use would greatly facilitate lab work. While no tool is perfect, the designs of the disclosed extraction implement greatly minimizes the risk of mishandling such substrates or breaking glass coverslips.

### SUMMARY OF THE INVENTION

The present disclosure is directed to an implement which may be used to grasp, manipulate, or extract a substrate, including out of a laboratory dish.

### BRIEF DESCRIPTION OF DRAWINGS

FIG. 1 is a perspective view of an embodiment of an extraction tool.

FIG. 2 is a plan view of an embodiment of an extraction tool.

FIG. 3 is a plan view of an extraction tool with arrows showing the direction of movement of the outer prongs.

FIG. 4 is an illustration showing the tool coming into contact with a coverslip in a lab dish.

FIG. 5 is an illustration showing the tool commencing to lift the coverslip out of the lab dish.

FIG. 6 is an illustration showing the tool grasping the coverslip which is removed from the lab dish.

FIG. 7 is a perspective view of an embodiment of an extraction tool grasping the coverslip which is removed from the lab dish.

FIG. 8 is a perspective view of an embodiment of an extraction tool.

FIG. 9 is a plan view of an embodiment of the extraction tool.

FIG. 10 is a plan view of an embodiment of an extraction tool with arrows showing the direction of movement of the outer prongs.

FIG. 11 is an illustration showing an embodiment of the tool coming into contact with a coverslip in a lab dish.

FIG. 12 is an illustration showing an embodiment of the tool commencing to lift the coverslip out of the lab dish.

FIG. 13 is an illustration showing an embodiment of the tool with one prong being placed under the coverslip.

### DETAILED DESCRIPTION

In handling substrates, extraction is an important step because the substrates are typically fragile. For example, glass coverslips are breakable because they are constructed of very thin glass. A broken coverslip will ruin an experiment.

The present implement allows a user to securely grasp a substrate, such as a coverslip, so as to minimize the risk of breakage. The description below is with respect to a glass coverslip even though the invention may be used with any type of substrate.

The present implement resembles a tweezer or forceps in that it has opposing prongs for gripping. It is designed to be held in one hand even though it may be used in different ways. The description below describes the implement as a tweezer held in one hand, although it is not so limited.

Such implements may be used for manipulation of delicate objects such as glass coverslips as well as filter discs or paper. Or they may be used in engineering fields for precision manipulation of small parts. They may also be used for dissection and examination of small samples. They may additionally be used to avoid direct handling of an object or specimen, for example in a clean-room environment.

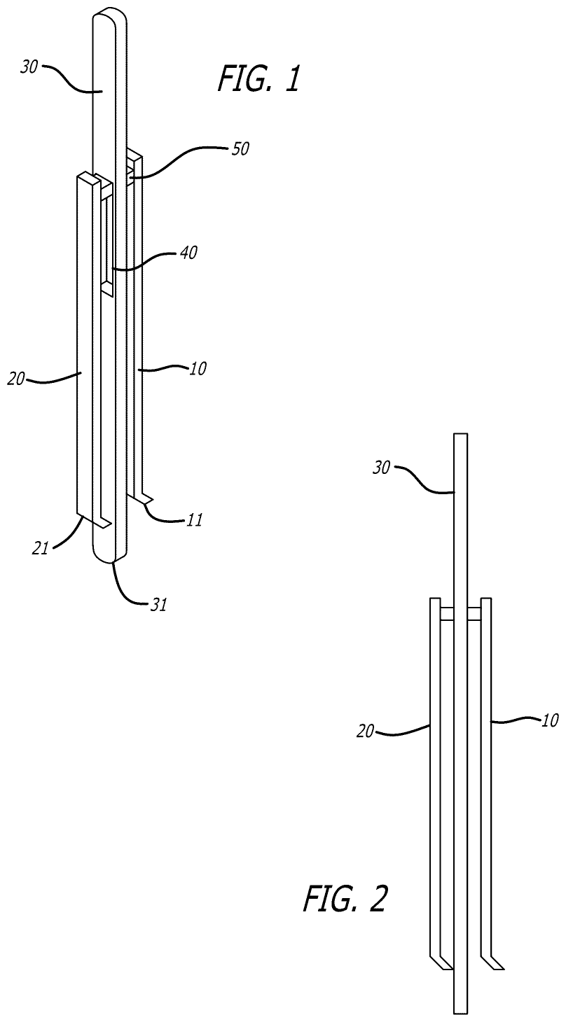

With reference to FIG. 1, the tweezer has three prongs 10, 20, and 30. Center prongs 30 may be considered as stationary, and outer prongs 10 and 20 may be considered to be relatively movable in a longitudinal direction with respect to prong 30. In the embodiment of FIG. 1, outer prongs 10 and 20 are in an elevated position with respect to stationary center prong 30. FIG. 2 is another view of this configuration. One of skill in the art will realize that stationary and movable are relative terms, and the choice of identifying prong 30 as stationary is arbitrary.

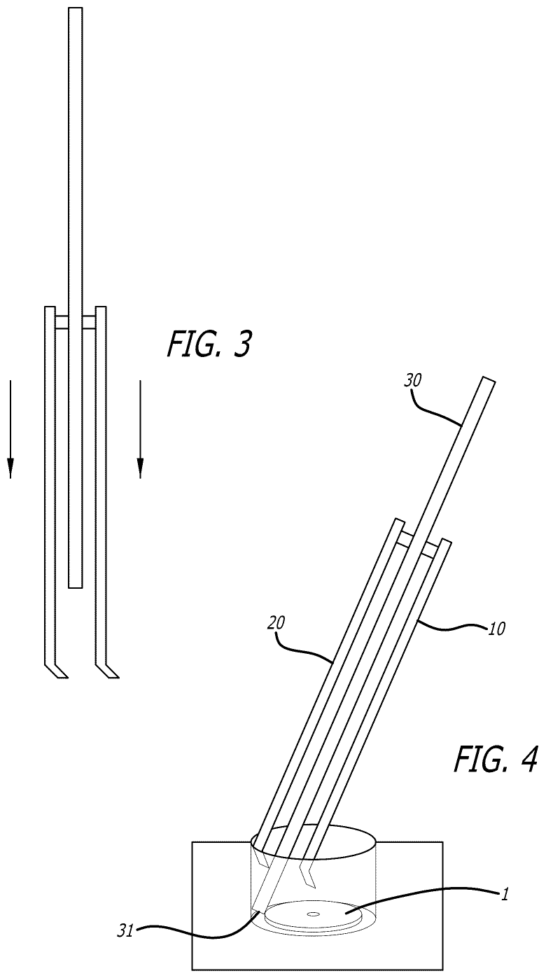

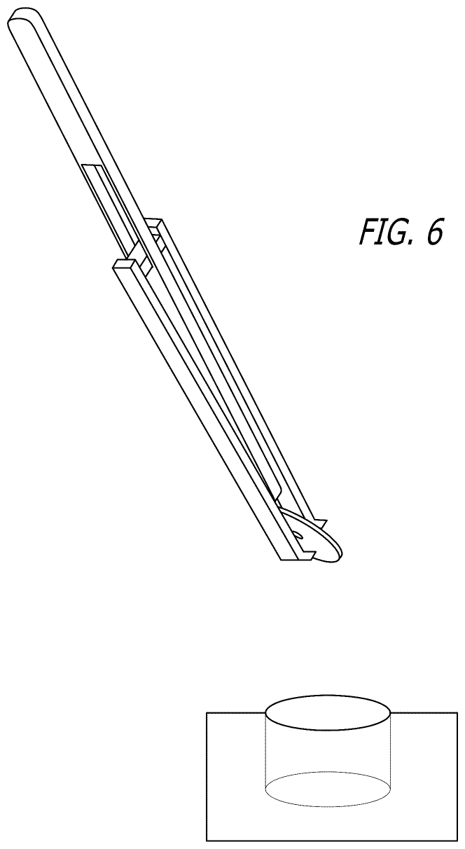

When the outer prongs 10 and 20 are raised or elevated as shown in FIG. 1, the terminus 31 of prong 30 extends past the bottoms 11 and 21 of the prongs 10 and 20. But when the outer prongs 10 and 20 are lowered or extended, the terminus 31 retracts above the terminus 11 and 21. FIG. 3, the shows such a configuration with prong 30 retracted allowing the prongs 10 and 20 to be pressed together to grasp a substrate as shown in FIG. 6.

As seem in FIG. 1, the ends of prongs 10 and 20 may be bent. In alternative embodiments, they may also be straight. Moreover, the bend may be at a 90 degree angle with respect to the longitudinal direction of the prong, or it may at an angle. The angle may be acute or obtuse.

In the embodiment of FIG. 1, the mechanism that permits relative movement between center prong 30 and outer prongs 10, 20 includes a slot 40 located on center prong 30 and a cross member 50 which slides up and down in the slot 40. Cross bar 50 is coupled to prong 10 at one end and to prong 20 at the other end. In this way, prongs 10 and 20 form a unitary body that slides up and down relative to prong 30.

In an alternative embodiment, prongs 10, 20 and cross bar 50 are formed as a single body with an opening in the cross bar which allows prong 30 to penetrate through and slide up and down. The cross bar acts as a bridge between prongs 10 and 20 and prong 30 slides up and down in the opening in the bridge. In this way, the relative movement is achieved by the prong 30 moving up and down with respect to the single body comprised of the prongs 10 and 20 and the bridge. The single body with the bridge may be formed integrally as a U-shaped form.

FIG. 4 shows the operation of the embodiment in FIG. 1. The prongs 10 and 20 are moved up to allow terminus 31 to extend into the lab dish and the coverslip 1. Terminus 31 can be place the edge of the coverslip and the wall of the lab dish so that prong 20 can be slid under the coverslip. Terminus 31 may then be used to push the coverslip away from the wall. Some tension may be placed on the coverslip to begin to lift it. This will allow prong 20 to slide under the coverslip.

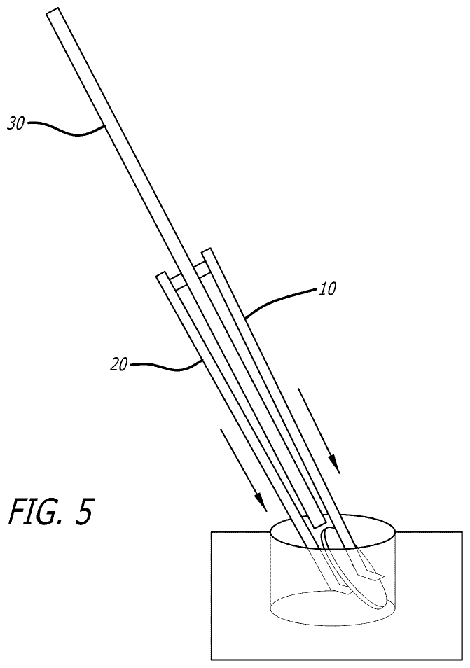

Once prong 20 is slipped under the coverslip, both prongs 10 and 20 can be used to grasp the coverslip forceps style. As seen in FIG. 5, at this stage, prongs 10 and 20 are extended below prong 30; or alternatively stated, prong 30 is retracted. In the embodiments where the ends 11 and 21 include a bend, the bent portion assists in positioning the prong under the coverslip. FIG. 6 shows the coverslip lifted out of the lab dish with the extraction tool.

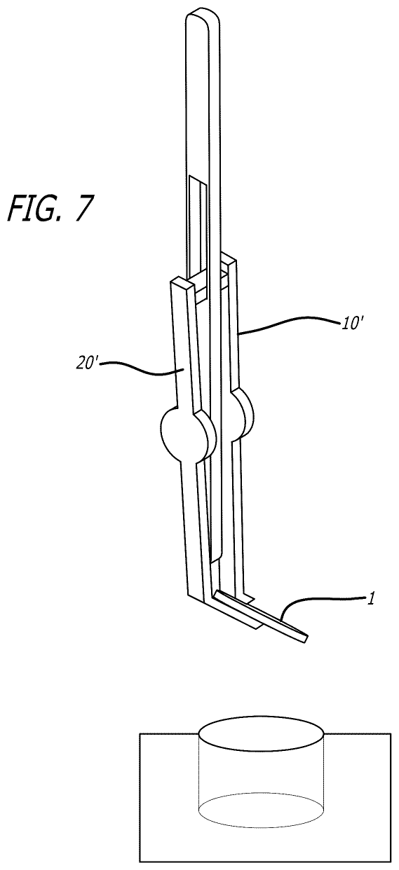

In embodiments where a bent portion exists at the ends of the prongs, one bent portion may be longer than the other. In such a configuration, the longer bent portion will facilitate positioning the extraction tool under the coverslip. FIG. 7 illustrates such usage.

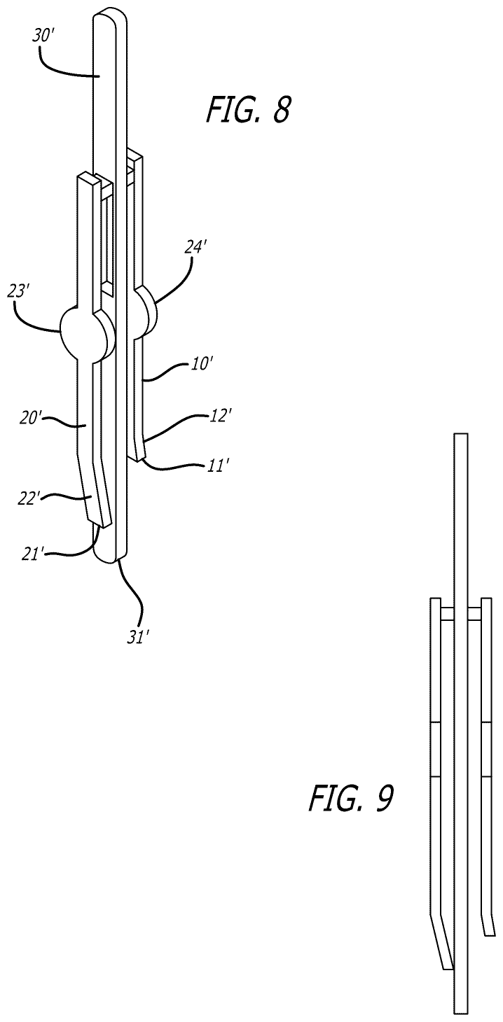

FIGS. 8-11 show an alternative embodiment of the extraction tool with asymmetric bent portions. Reference number to similar parts in FIG. 1 are designated with a prime. Prongs 10′ and 20′ include terminuses 11′ and 21′. The bent portion on prong 10′ is 12′ and the bent portion on prong 20′ is referenced as 22′. The bent portion may be low-angled, for example as seen in FIG. 8, or more bent, for example as shown in FIG. 11.

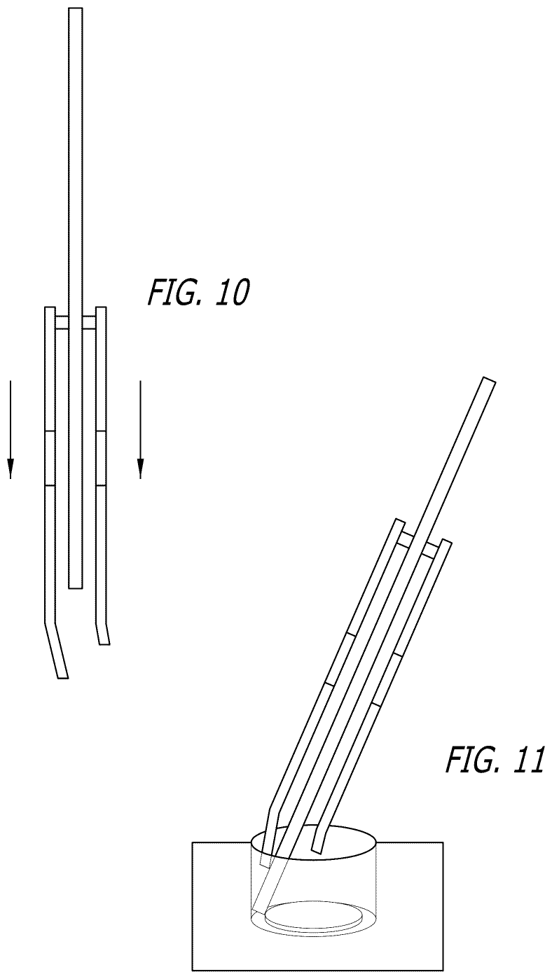

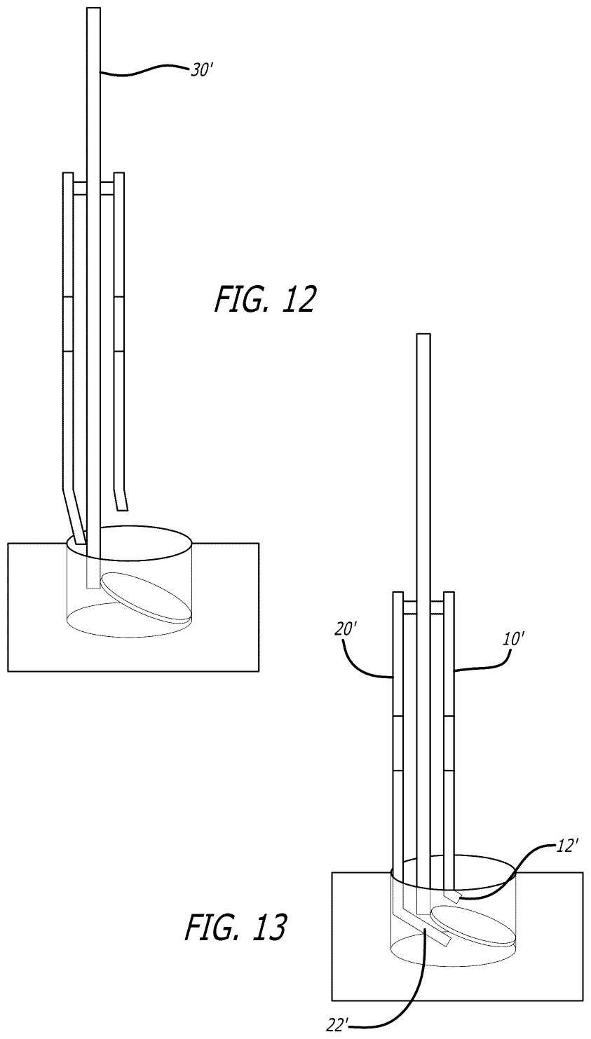

As seen in FIGS. 10-11, the extraction tool is used by lowering prong 30′ in to the lab dish and against the coverslip. The bent portion 22′ of prong 20′ is then positioned under the coverslip. Then, both prongs 10′ and 20′ are used to grasp the coverslip as shown in FIG. 7.

In an alternative embodiment, each of the prongs may have a portion especially adapted to facilitate grip. This portion may include a different configuration, different materials, ridges, rubber, and a variety of known grip facilitators. In the embodiment of FIG. 8, these grip facilitating portions are in the form of enlarged areas 23′ and 24′.

In an alternative embodiment, the extraction tool resembles traditional tweezers or forceps which includes a slender center prong coupled to the tweezer bridge. The two tweezer prongs surround the center prong and move vertically, sliding up and down in respect to the center prong.

In yet another embodiment, the terminus of the center prong, 31 or 31′ as shown in FIGS. 1 and 8, may include a grip-enhancing feature. For example it could include rubber or a coating of tacky material which aids grip. For example, it could include a flattened portion. For example, it could include ridges or a rough portion. For example, it could include a surface pattern such as those found on nail files.

In yet another embodiment, the extraction tool may be marked or labeled to identify which side is the top and which side should be used for grasping the coverslip. Additionally, the tool may be marked or labeled to identify which prong to place under the coverslip. Such markings have an additional benefit in helping the user also identify which side of the coverslip is up. That is, typically there are cells on side of the coverslip, and this is not always visible or obvious to the naked eye. Identification of which prong was placed under the coverslip during extraction also assists in remembering which side of the coverslip to lay down.

1. An extraction tool comprising:
two outer prongs each having an end portion; wherein the two outer prongs are coupled to each other; wherein the two outer prongs define a longitudinal direction along their length;
a center prong positioned between the two outer prongs and coupled thereto; wherein the center prong and the two outer prongs are configured for relative movement in the longitudinal direction between the two outer prongs and the center prong.

2. The extraction tool according to claim 1 wherein each end portion of each of the two outer prongs comprises a material which improves grip.

3. The extraction tool according to claim 1 wherein each end portion of each of the two outer prongs comprises a bent portion.

4. The extraction tool according to claim 3 wherein one said bent portion is longer than the other.

5. The extraction tool according to claim 1 wherein the center prong comprises an end portion and wherein said end portion comprises a grip-enhancing portion.

6. The method of extracting a substrate from a container comprising the steps of:
providing a tool comprising two outer prongs each having an end portion; wherein the two outer prongs are coupled to each other; wherein the two outer prongs define a longitudinal direction along their length;
providing a center prong having a terminus, the center prong positioned between the two outer prongs and coupled thereto; wherein the center prong and the two outer prongs are configured for relative movement in the longitudinal direction between the two outer prongs and the center prong;
displacing the center prong in a downward direction so as to move the terminus away from the end portions of the two outer prongs;
placing the terminus against the substrate;
positioning one of said two outer prongs under the substrate; and
using the two outer prongs to grasp the substrate.

7. The method according to claim 6 wherein each end portion of each of the two outer prongs comprises a material which improves grip.

8. The method according to claim 6 wherein each end portion of each of the two outer prongs comprises a bent portion.

9. The method according to claim 8 wherein one said end portion is longer than the other.

10. The method of making an extraction tool comprising the steps of:
providing a first outer prong having a first end portion and a second outer prong having a second end portion; wherein each of said first and second outer prongs longitudinal direction along their length;
coupling the first and second outer prongs together so that the first and second end portions can be squeezed together by pinching the first and second ends portions;
providing a center prong having a terminus;
positioning the center prong between the first and second outer prongs; and
coupling the center prong to the first and second outer prong to permit relative movement in the longitudinal direction between the center prong and the first and second outer prongs.

11. The method according to claim 10 wherein each of the first and second end portions comprises a material which improves grip.

12. The method according to claim 10 wherein each of the first and second end portions comprises a bent portion.

13. The method according to claim 12 wherein one said bent portion is longer than the other.
